(19) United States
(12) Patent Application Publication
(10) Pub. No.: US 2018/0039505 A1
(43) Pub. Date: Feb. 8, 2018

(54) PREVENTING FLOW INTERRUPTION CAUSED BY MIGRATION OF VM

(71) Applicant: HEWLETT PACKARD ENTERPRISE DEVELOPMENT LP, Houston, TX (US)

(72) Inventor: Changwang Lin, Beijing (CN)

(21) Appl. No.: 15/550,745

(22) PCT Filed: Feb. 4, 2016
(86) PCT No.: PCT/CN2016/073485

§ 371 Date: Aug. 11, 2017

(30) Foreign Application Priority Data
Feb. 12, 2015 (CN) 201510074016.1

(51) Int. Cl. G06F 9/455; G06F 17/30

(52) U.S. Cl. CPC G06F 9/45558; G06F 17/30477; G06F 2009/4557

(57) ABSTRACT

When determining that a first Virtual Machine (VM) migrates from the first xTR, the first xTR determines whether a second VM is connected to an interface of the first xTR to which the first VM is connected before the first VM migrates. If yes, the first xTR sends a free Address Resolution Protocol (ARP) packet through the interface of the first xTR, and sends an Endpoint Identifier (EID) address of the second VM and a Routing Locator (RLOC) address of the first xTR to a second xTR. A source address and destination address of the free ARP are the EID address of the first VM, and the second xTR is an xTR to which the first VM migrates from the first xTR.

### BACKGROUND

In Locator/Identity Separation Protocol (LISP), a network may be established based on a locator/identity separation idea and two separated address spaces are formed, which includes a Routing Locator (RLOC) address and an Endpoint Identifier (EID) address.

The RLOC address is an address of a LISP router. The RLOC address may be forwarded in Internet, routed globally and aggregated according to network topology.

The EID address is a Virtual Machine (VM) address of a communication endpoint, and has a separated address space. In a LISP network, the EID address may migrate without depending on the RLOC address.

### BRIEF DESCRIPTION OF THE DRAWINGS

Features of the present disclosure are illustrated by way of example and not limited in the following figure(s), in which like numerals indicate like elements, in which:

FIG. 1 is a diagram illustrating the structure of a LISP network according to some examples of the present disclosure.

FIG. 2 is a flowchart illustrating a method for preventing flow interruption caused by the migration of a VM according to some examples of the present disclosure.

FIG. 3 is a flowchart illustrating a method for preventing flow interruption caused by the migration of a VM according to some examples of the present disclosure.

FIG. 4 is a diagram illustrating the format of a map-notify packet according to some examples of the present disclosure.

FIG. 5 is a diagram illustrating the structure of an apparatus for preventing flow interruption caused by the migration of a VM according to some examples of the present disclosure.

FIG. 6 is a diagram illustrating the hardware structure of an apparatus for preventing flow interruption caused by the migration of a VM according to some examples of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

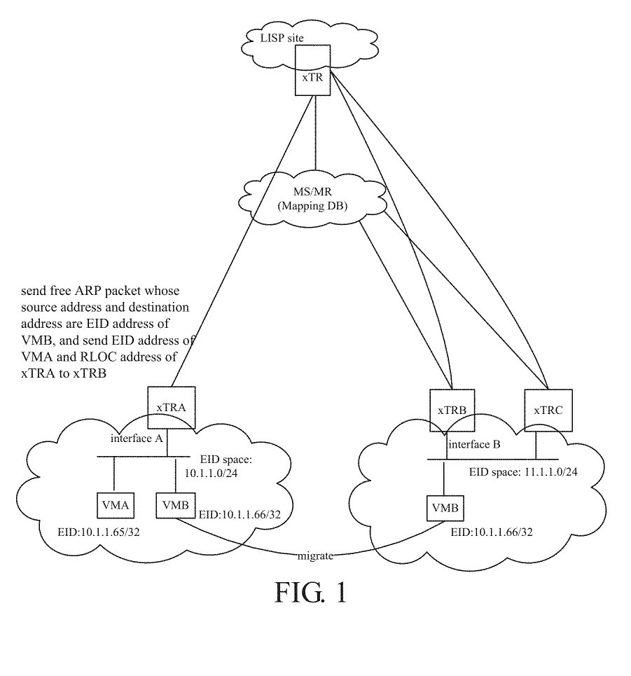

FIG. 1 is a diagram illustrating the structure of a LISP network according to some examples of the present disclosure. As shown in FIG. 1, the LISP network includes an edge device (xTR) and a mapping DataBase (DB).

The xTR may encapsulate and decapsulate a data packet.

The Mapping DB may contain a mapping relationship between an EID address and a RLOC address, and may distribute the mapping relationship through a Mapping Server (MS).

In a LISP network, a VM may be necessary to migrate sometimes to safely operate, maintain and manage a data center. When a VM migrates across a network segment, a flow between the migrating VM and another VM communicating with the migrating VM directly may be interrupted. For example, in a LISP network shown in FIG. 1, VMA and VMB are connected to the same interface of xTRA, where the interface of xTRA is recorded as interface A. The VMA learns an Address Resolution Protocol (ARP) entry corresponding to the VMB, and the VMB also learns an ARP entry corresponding to the VMA. Since the VMA and the VMB are both connected to the interface A of the xTRA, the ARP entry corresponding to the VMB that has been learned by the VMA can ensure the direct communication between the VMA and the VMB without the transfer of the xTRA. Similarly, the ARP entry corresponding to the VMA that has been learned by the VMB can ensure the direct communication between the VMA and the VMB without the transfer of the xTRA. In an example, suppose the VMB migrates from the xTRA in a network segment of 10.1.1.0/24 to xTRB in another network segment of 11.1.1.0/24. Since the ARP entry corresponding to the VMB that has been learned by the VMA still exists when the VMA accesses the VMB, the VMA sends a packet according to the learned ARP entry corresponding to the VMB. However, since the ARP entry corresponding to the VMB is learned by the VMA before the VMB migrates, the packet sent by the VMA is unable to arrive at the VMB if the VMA uses the previously learned ARP entry corresponding to the VMB. In this case, a flow sent to the VMB by the VMA may be interrupted. Similarly, when the VMB accesses the VMA, since the VMB uses the ARP entry corresponding to the VMA that has been learned by the VMB before the VMA migrates, a packet sent by the VMB is unable to arrive at the VMA. In this case, a flow sent to the VMA by the VMB may be interrupted.

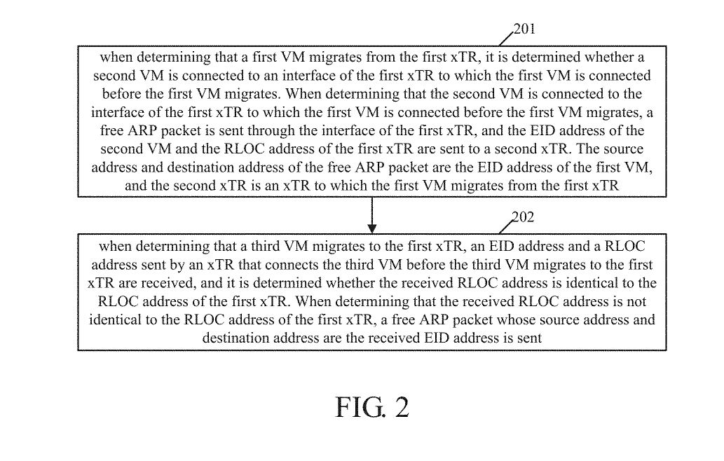

FIG. 2 is a flowchart illustrating a method for preventing flow interruption caused by the migration of a VM according to some examples of the present disclosure. The method may be applied to a first xTR in a LISP network. As shown in FIG. 2, the method includes following blocks.

At block 201, when determining that a first VM migrates from the first xTR, it is determined whether a second VM is connected to an interface of the first xTR to which the first VM is connected before the first VM migrates. When determining that the second VM is connected to the interface of the first xTR to which the first VM is connected before the first VM migrates, a free ARP packet is sent through the interface of the first xTR, and the EID address of the second VM and the RLOC address of the first xTR are sent to a second xTR. The source address and destination address of the free ARP packet are the EID address of the first VM, and the second xTR is an xTR to which the first VM migrates from the first xTR.

In an example of block 201, the source Media Access Control (MAC) address of the free ARP packet sent by the first xTR is the MAC address of the first xTR. If the first xTR is a device in a Virtual Router Redundancy Protocol (VRRP) backup group virtualized by multiple devices, the MAC address of the first xTR is the virtual MAC address of the VRRP backup group to which the first xTR belongs. If the first xTR is a single device and does not belong to the VRRP backup group, the MAC address of the first xTR is the MAC address of the interface of the first xTR through which the free ARP packet is sent.

As described at block 201, when the first xTR determines that the second VM is connected to the interface of the first xTR to which the first VM is connected before the first VM migrates, the first xTR sends the free ARP packet through the interface of the first xTR to which the first VM is connected, where the source address and destination address of the free ARP packet are both the EID address of the first VM. After receiving the free ARP packet, the second VM updates an original ARP entry corresponding to the source address according to an interface receiving the free ARP packet and the source address and the source MAC address contained in the free ARP packet. The second VM is another VM connected to the interface of the first xTR to which the first VM is connected.

For example, in the LISP network shown in FIG. 1, the VMA and the VMB are connected to the same interface of the xTRA before the VMB migrates, where the interface of the xTRA is recorded as interface A. After the xTRA determines that the VMB migrates from the xTRA, the xTRA sends a free ARP packet through the interface A, where the source address and destination address of the free ARP packet are the EID address of the VMB and the source MAC address of the free ARP packet is the MAC address of the xTRA. After receiving the free ARP packet sent by the xTRA, the VMA updates an original ARP entry corresponding to the source address (i.e., the EID address of the VMB) according to an interface receiving the free ARP packet and the source address (i.e., the EID address of the VMB) and the source MAC address contained in the free ARP packet. Since the VMA and the VMB are connected to the same interface (i.e., the interface A) of the xTRA, the ARP entry corresponding to the EID address of the VMB that has existed on the VMA before the VMB migrates contains the MAC address and EID address of the VMB and an egress interface that is an interface through which the VMA is connected to the VMB. After the VMB migrates from the xTRA, the VMA receives the free ARP packet sent by the xTRA, and updates the original ARP entry corresponding to the source address (i.e., the EID address of the VMB) into a new ARP entry according to the interface receiving the free ARP packet and the source address (i.e., the EID address of the VMB) and the source MAC address contained in the free ARP packet. The new ARP entry contains the source MAC address of the free ARP packet (i.e., the MAC address of the xTRA), the EID address of the VMB and the egress interface that is the interface through which the VMA receives the free ARP packet. In this case, the VMA may access the VMB based on the new ARP entry corresponding to the VMB, rather than access the VMB based on the ARP entry corresponding to the VMB that has been learned before the VMB migrates, thereby preventing flow interruption when the VMA accesses the VMB.

Referring to FIG. 2, at block 202, when determining that a third VM migrates to the first xTR, a second EID address and a second RLOC address sent by an xTR that connects the third VM before the third VM migrates to the first xTR are received, and it is determined whether the received second RLOC address is identical to the RLOC address of the first xTR. When determining that the received second RLOC address is not identical to the RLOC address of the first xTR, a second free ARP packet whose source address and destination address are the received second EID address is sent.

In an example of the present disclosure, it is possible that multiple VMs migrate to the first xTR. The first xTR receives an EID address and a RLOC address sent by an xTR that connects each of the multiple VMs before the VM migrates to the first xTR, and determines whether the received RLOC address is identical to the RLOC address of the first xTR. When determining that the received RLOC address is not identical to the RLOC address of the first xTR, the first xTR sends a free ARP packet whose source address and destination address are the received EID address.

In an example of block 202, the source MAC address of the free ARP packet sent by the first xTR is the MAC address of the first xTR. As mentioned above, if the first xTR is a device in a VRRP backup group virtualized by multiple devices, the MAC address of the first xTR is the virtual MAC address of the VRRP backup group to which the first xTR belongs. If the first xTR is a single device and does not belong to the VRRP backup group, the MAC address of the first xTR is the MAC address of the interface of the first xTR through which the free ARP packet is sent.

In an example of block 202, the first xTR may send the free ARP packet whose source address and destination address are the received EID address through an interface of the first xTR that connects the migrating VM. In this case, it can be avoided that a large number of free ARP packets are flooded in the LISP network.

As described at block 202, the EID address received by the first xTR is the EID address of another VM that is connected to the interface of an xTR to which the third VM is also connected before migrating to the first xTR. The third VM is a VM migrating to the first xTR. In this case, after the first xTR sends the free ARP packet whose source address and destination address are the received EID address, the migrating third VM receives the free ARP packet. After receiving the free ARP packet, the third VM updates an original ARP entry corresponding to the source address according to the interface receiving the free ARP packet and the source address and the source MAC address contained in the free ARP packet.

In another example of the LISP network shown in FIG. 1, before the VMB migrates from the xTRA to the xTRB, the VMA and the VMB are connected to the same interface of the xTRA, where the interface of the xTRA is recorded as interface A. After the VMB migrates from the xTRA to the xTRB, according to block 202 of FIG. 2, the xTRA sends the EID address of the VMA and the RLOC address of the xTRA to the xTRB. After receiving the EID address of the VMA and the RLOC address of the xTRA from the xTRA, the xTRB determines whether the received RLOC address of the xTRA is identical to the RLOC address of the xTRB. If the received RLOC address of the xTRA is not identical to the RLOC address of the xTRB, the xTRB sends a free ARP packet through an interface of the xTRB through which the VMB is connected, where the interface of the xTRB is recorded as interface B. The source address and destination address of the free ARP packet are the EID address of the VMA and the source MAC address of the free ARP packet is the MAC address of the xTRB. After receiving the free ARP packet sent by the xTRB, the VMB updates the original ARP entry corresponding to the source address (i.e., the EID address of the VMA) according to the interface receiving the free ARP packet and the source address (i.e., the EID address of the VMA) and the source MAC address contained in the free ARP packet. For example, since the VMA and the VMB are connected to the same interface (i.e., the interface A) of the xTRA, the ARP entry corresponding the EID address of the VMA that has been existed on the VMB before the VMB migrates from the xTRA contains the MAC address and EID address of the VMA, and an egress interface that is an interface through which the VMB is connected to the VMA. After the VMB migrates from the xTRA to the xTRB, the VMB receives a free ARP packet sent by the xTRB, and updates the original ARP entry corresponding to the source address (i.e., the EID address of the VMA) into a new ARP entry according to the interface receiving the free ARP packet and the source address (i.e., the EID address of the VMA) and the source MAC address contained in the free ARP packet. The new ARP entry contains the source MAC address of the free ARP packet (i.e., the MAC address of the xTRB), the EID address of the VMA and an egress interface that is the interface through which the VMB receives the free ARP packet. In this case, the VMB may access the VMA based on the new ARP entry corresponding to the VMA, rather than access the VMA based on the ARP entry corresponding to the VMA that has been learned before the VMB migrates, thereby preventing flow interruption when the VMB accesses the VMA.

According to the method shown in FIG. 2, when one of VMs connected to the same interface of an xTR migrates, it can be ensured that a flow between the migrating VM and another one of the VMs connected to the same interface of the xTR is not interrupted.

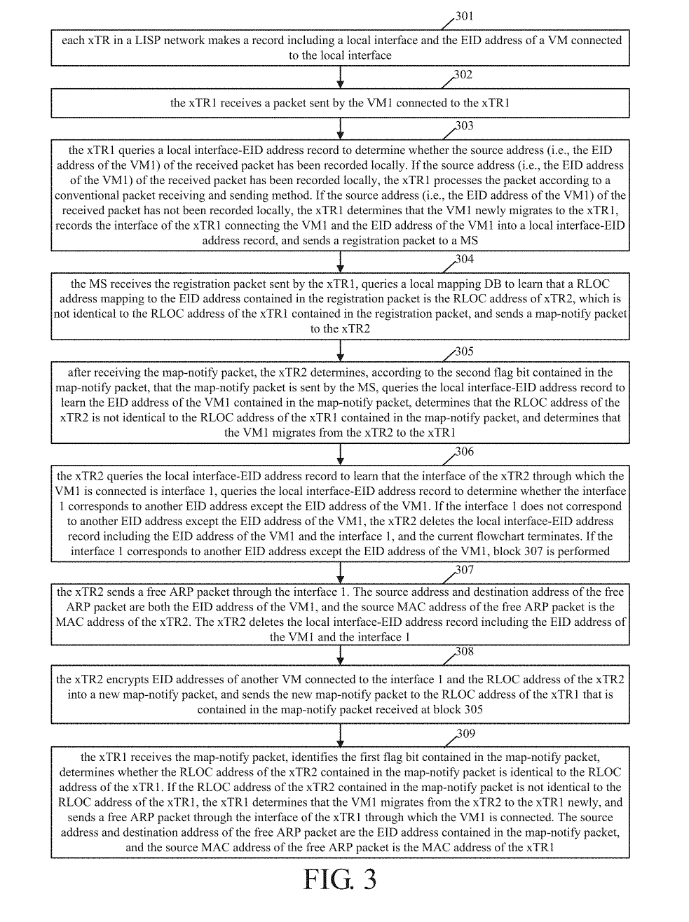

FIG. 3 is a flowchart illustrating a method for preventing flow interruption caused by the migration of a VM according to some examples of the present disclosure. As shown in FIG. 3, the method includes following blocks.

At block 301, each xTR in a LISP network makes a record including a local interface and the EID address of a VM connected to the local interface.

In an example, block 301 may be performed when the xTR dynamically finds that a new VM migrates to it.

For convenience of description, the record including the interface and the EID address of the VM connected to the interface that is made by the xTR is called an interface-EID address record. In an example, any xTR in the LISP network is called xTR1, and any VM connected to the xTR1 in the LISP network is called VM1. Accordingly, the xTR1 is not limited to a certain xTR, and the VM1 is also not limited to a certain VM.

At block 302, the xTR1 receives a packet sent by the VM1 connected to the xTR1.

When the VM1 accesses another VM, if the VM1 finds that an ARP entry corresponding to the EID address of the VM does not exist locally, the VM sends an ARP packet. If the VM1 finds that the ARP entry corresponding to the EID address of the VM exists locally, the VM1 sends a data packet. Accordingly, the packet received by the xTR1 may be either an ARP packet or a data packet. Herein, the source address of the ARP packet or the data packet is the EID address of the VM1.

At block 303, the xTR1 queries a local interface-EID address record to determine whether the source address (i.e., the EID address of the VM1) of the received packet has been recorded locally. If the source address (i.e., the EID address of the VM1) of the received packet has been recorded locally, the xTR1 processes the packet according to a conventional packet receiving and sending method. If the source address (i.e., the EID address of the VM1) of the received packet has not been recorded locally, the xTR1 determines that the VM1 newly migrates to the xTR1, records the interface of the xTR1 connecting the VM1 and the EID address of the VM1 into a local interface-EID address record, and sends a registration packet to a MS. Then, block 304 is performed.

In this example, the registration packet sent by the xTR1 contains the RLOC address of the xTR and the EID address of the VM1.

In an example of block 303, the xTR1 queries the local interface-EID address record according to the interface receiving the packet to determine whether EID addresses corresponding to the interface include the source address of the received packet (i.e., the EID address of the VM1). If the EID addresses corresponding to the interface include the source address of the received packet (i.e., the EID address of the VM1), the xTR1 determines that the VM1 does not migrate to the xTR1 newly, and processes the received packet according to a conventional packet receiving and sending method. If the EID addresses corresponding to the interface do not include the source address of the received packet (i.e., the EID address of the VM11), the xTR1 determines that the VM1 migrates to the xTR1 newly, and sends a registration packet to the MS, so that the EID address of the VM1 may be registered to the MS.

At block 304, the MS receives the registration packet sent by the xTR1, queries a local mapping DB to learn that a RLOC address mapping to the EID address contained in the registration packet is the RLOC address of xTR2, which is not identical to the RLOC address of the xTR1 contained in the registration packet, and sends a map-notify packet to the xTR2.

In an example, the map-notify packet contains the RLOC address of the xTR1 and the EID address of the VM1.

In order to distinguish the map-notify packet sent by the MS from the map-notify packet sent by the xTR2 at block 308, the map-notify packet may be improved as follows.

When the xTR2 is to send the map-notify packet at block 308, a first flag bit for indicating that the map-notify packet is sent by an xTR may be added to the map-notify packet.

When the MS is to send the map-notify packet, a second flag bit for indicating that the map-notify packet is sent by the MS may be added to the map-notify packet.

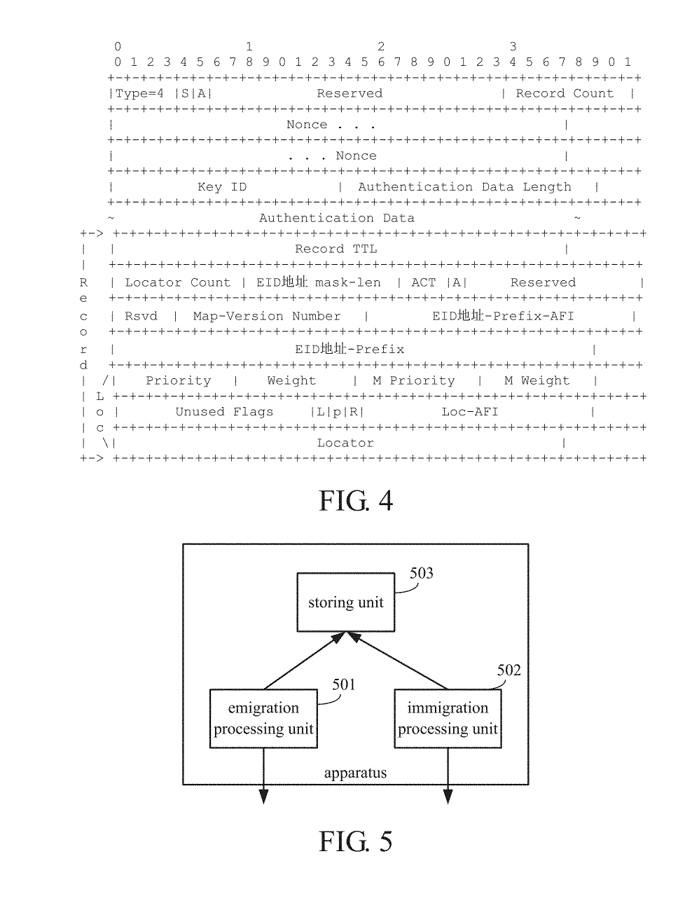

FIG. 4 is a diagram illustrating the format of a map-notify packet according to some examples of the present disclosure. As illustrated herein, the first flag bit in the map-notify packet is recorded as A, and the second flag bit is recorded as S.

Referring again to FIG. 3, based on the description herein, the map-notify packet sent by the MS at block 304 contains the second flag bit.

At block 305, after receiving the map-notify packet, the xTR2 determines, according to the second flag bit contained in the map-notify packet, that the map-notify packet is sent by the MS, queries the local interface-EID address record to learn the EID address of the VM1 contained in the map-notify packet, determines that the RLOC address of the xTR2 is not identical to the RLOC address of the xTR1 contained in the map-notify packet, and determines that the VM1 migrates from the xTR2 to the xTR1.

Block 305 may be an example of determining that the first VM migrates from the first xTR at block 201.

At block 306, the xTR2 queries the local interface-EID address record to learn that the interface of the xTR2 through which the VM1 is connected is interface 1, queries the local interface-EID address record to determine whether the interface 1 corresponds to another EID address except the EID address of the VM1. If the interface 1 does not correspond to another EID address except the EID address of the VM1, the xTR2 deletes the local interface-EID address record including the EID address of the VM1 and the interface 1, and the current flowchart terminates. If the interface 1 corresponds to another EID address except the EID address of the VM1, block 307 is performed.

Block 306 may be an example of determining whether the second VM is connected to the interface of the first xTR to which the first VM is connected before the first VM migrates at block 201.

At block 307, the xTR2 sends a free ARP packet through the interface 1. The source address and destination address of the free ARP packet are both the EID address of the VM1, and the source MAC address of the free ARP packet is the MAC address of the xTR2. The xTR2 deletes the local interface-EID address record including the EID address of the VM1 and the interface 1. Then, block 308 is performed.

At block 307, after the xTR2 sends the free ARP packet through the interface 1, another VM connected to the interface 1 receives the free ARP packet. After receiving the free ARP packet, the VM updates an original ARP entry corresponding to the source address according to an interface receiving the free ARP packet and the source address and the source MAC address contained in the free ARP packet.

For example, before the VM1 migrates from the xTR2, the VM1 and the VM2 are both connected to the interface 1 of the xTR2. After determining that the VM1 migrates from the xTR2 to the xTR1, the xTR2 sends a free ARP packet through the interface 1. The source address and destination address of the free ARP packet are both the EID address of the VM1, and the source MAC address of the free ARP packet is the MAC address of the xTR2. After receiving the free ARP packet sent by the xTR2, the VM2 updates an original ARP entry corresponding to the source address (i.e., the EID address of the VM1) according to the interface receiving the free ARP packet and the source address (i.e., the EID address of the VM1) and the source MAC address contained in the free ARP packet. For example, since the VM1 and the VM2 are connected to the same interface 2 of the xTR2 before the VM migrates from the xTR2, the ARP entry corresponding to the EID address of the VM2 that has been learned by the VM2 contains the MAC address and EID address of the VM1, and an egress interface that is an interface through which the xTR2 connects the VM1. After the VM1 migrates from the xTR2 to the xTR1, the xTR2 sends a free ARP packet through the interface 1. The source address and destination address of the free ARP packet is the EID address of the VM1, and the source MAC address of the free ARP packet is the MAC address of the xTR2. After receiving the free ARP packet sent by the xTR2, the VM2 updates the original ARP entry corresponding to the source address (i.e., the EID address of the VM1) into a new ARP entry according to the interface receiving the free ARP packet and the source address (i.e., the EID address of the VM1) and the source MAC address contained in the free ARP packet. The new ARP entry contains the source MAC address of the free ARP packet (i.e., the MAC address of the xTR2), the EID address of the VM1 and an egress interface that is an interface through which the VM2 receives the free ARP packet. Subsequently, the VM2 may access the VM1 based on the new ARP entry corresponding to the EID address of the VM1. Since the egress interface in the new ARP entry corresponding to the EID address of the VM1 is the interface through which the VM2 receives the free ARP packet, it can be ensured that a packet for accessing the VM1 by the VM2 can be forwarded to the VM1 by the xTR2 through the LISP network, rather than sent to the VM1 according to the original ARP entry corresponding to the VM1 that has existed before the VM1 migrates. The original ARP entry may be used for accessing the VM1 directly by the VM2. Accordingly, flow interruption can be prevented when the VM2 accesses the VM1.

At block 308, the xTR2 encrypts EID addresses of another VM connected to the interface 1 and the RLOC address of the xTR2 into a new map-notify packet, and sends the new map-notify packet to the RLOC address of the xTR1 that is contained in the map-notify packet received at block 305. In an example, there may be multiple VMs connected to the interface 1.

In an example, block 307 may be performed firstly, and then block 308 may be performed. In another example, block 308 may be performed firstly, and then block 307 may be performed. For convenience of description, in the example of the present disclosure, block 307 is described firstly, and then block 308 is described. In order to distinguish the map-notify packet sent by the MS from the map-notify packet sent by the xTR, a first flag bit for indicating that the map-notify packet is sent by the xTR is added to the map-notify packet sent by the xTR at block 308.

Block 308 may be an example of sending the EID addresses of the second VM and the RLOC address of the first xTR to the second xTR at block 201.

At block 309, the xTR1 receives the map-notify packet, identifies the first flag bit contained in the map-notify packet, determines whether the RLOC address of the xTR2 contained in the map-notify packet is identical to the RLOC address of the xTR1. If the RLOC address of the xTR2 contained in the map-notify packet is not identical to the RLOC address of the xTR1, the xTR1 determines that the VM1 migrates from the xTR2 to the xTR1 newly, and sends a free ARP packet through the interface of the xTR1 through which the VM1 is connected. The source address and destination address of the free ARP packet are the EID address contained in the map-notify packet, and the source MAC address of the free ARP packet is the MAC address of the xTR1.

Block 309 may be performed after the xTR1 queries the local interface-EID address record and determines that the local interface-EID address record does not include the EID address of the VM1 at block 303. As described at block 303, the xTR1 sends a registration packet to the MS. Normally, the xTR1 can receive a map-notify packet responding to the registration packet from the MS. However, when block 309 is performed, the map-notify packet received by the xTR1 contains the first flag bit for indicating that the map-notify packet is sent by an xTR instead of the MS. After receiving the map-notify packet containing the first flag bit, the xTR1 determines whether the RLOC address of the xTR2 contained in the map-notify packet is identical to the RLOC address of the xTR1. If the RLOC address of the xTR2 contained in the map-notify packet is not identical to the RLOC address of the xTR1, the xTR1 determines, according to the RLOC address of the xTR2 contained in the map-notify packet, that the VM1 migrates from the xTR2 to the xTR1, rather than always connected to the xTR1 directly. The xTR1 sends a free ARP packet through the interface of the xTR1 through which the VM1 is connected. The source address and destination address of the free ARP packet are the EID address contained in the map-notify packet, and the source MAC address of the free ARP packet is the MAC address of the xTR1. Block 309 may be an example of block 202.

As described at block 308, the EID address contained in the map-notify packet sent to the xTR1 by the xTR2 is the EID address of another VM connected to the interface of the xTR2 to which the VM1 is connected before migrating from the xTR2. After the xTR1 receives the map-notify packet sent by the xTR2 and sends a free ARP packet whose source address and destination address is the EID address contained in the map-notify packet, the VM1 migrating to the xTR1 receives the free ARP packet necessarily. After receiving the free ARP packet, the VM1 updates the original ARP entry corresponding to the source address according to the interface receiving the free ARP packet and the source address and the source MAC address contained in the free ARP packet.

In an example, suppose the VM1 and the VM2 are connected to the interface 1 of the xTR2 before the VM1 migrates from the xTR2. After the xTR2 determines that the VM1 migrates from the xTR2 to the xTR1, according to block 308, the xTR2 encapsulates the EID address of the VM2 connected to the interface 1 and the RLOC address of the xTR2 into a new map-notify packet, and sends the new map-notify packet to the RLOC address of the xTR1. When block 309 is performed, the xTR1 receives the map-notify packet sent by the xTR2 and identifies the first flag bit contained in the map-notify packet. When determining that the RLOC address of the xTR2 contained in the map-notify packet is not identical to the RLOC address of the xTR1, the xTR1 sends a free ARP packet through the interface of the xTR1 through which the VM1 is connected. The source address and destination address of the free ARP packet are the EID address of the VM2 contained in the map-notify packet and the source MAC address of the free ARP packet is the MAC address of the xTR1. After receiving the free ARP packet sent by the xTR1, the VM1 updates the original ARP entry corresponding to the source address (i.e., the EID address of the VM2) according to the interface receiving the free ARP packet and the source address (i.e., the EID address of the VM2) and the source MAC address contained in the free ARP packet. For example, since the VM1 and the VM2 are connected to the same interface 1 of the xTR2 before the VM1 migrates from the xTR2, the ARP entry corresponding to the EID address of the VM2 that has been learned by the VM1 contains the MAC address and EID address of the VM2 and an egress interface that is an interface through which the VM1 is connected to the VM2. After the VM1 migrates from the xTR2 to the xTR1, the VM1 receives the free ARP packet sent by the xTR1, and updates the original ARP entry corresponding to the source address (i.e., the EID address of the VM2) into a new ARP entry according to the interface receiving the free ARP packet and the source address (i.e., the EID address of the VM2) and the source MAC address contained in the free ARP packet. The new ARP entry contains the source MAC address of the free ARP packet (i.e., the MAC address of the xTR1), the EID address of the 3VM2 and an egress interface that is the interface through which the VM1 receives the free ARP packet. Subsequently, the VM1 may access the VM2 based on the new ARP entry corresponding to the EID address of the VM2. Since the egress interface in the new ARP entry corresponding to the EID address of the VM2 is the interface through which the VM1 receives the free ARP packet, it can be ensured that a packet for accessing the VM2 by the VM1 can be forwarded to the VM2 by the xTR1 through the LISP network, rather than sent to the VM2 according to the original ARP entry corresponding to the VM2 that has existed before the VM1 migrates. The original ARP entry may be used for accessing the VM2 directly by the VM1. Accordingly, flow interruption can be prevented when the VM1 accesses the VM2.

And thus, the flowchart shown in FIG. 3 terminates.

Hereinafter, the flowchart shown in FIG. 3 is described according to an example.

The LISP network shown in FIG. 1 includes xTRA and xTRB. The RLOC address of the xTRA is 1.1.1.1, and the RLOC address of the xTRB is 2.2.2.2. In FIG. 1, the EID address of VMA is 10.1.1.65, the EID address of VMB is 10.1.1.66, and the VMA and the VMB are connected to the same interface of the xTRA, where the interface of the xTRA is recorded as interface A. According to block 301 shown in FIG. 3, an original local interface-EID address record of the xTRA includes the interface A and the EID address of the VMA and the EID address of the VMB, as shown in a following table.

| | |
|---|---|
| interface | EID address of VM |
| interface A | EID address of VMA |
| | EID address of VMB |

The ARP entry corresponding to the EID address of the VMB (i.e., 10.1.1.66) that has been learned by the VMA includes: 10.1.1.66, the MAC address of the VMB and an egress interface that is an interface through which the VMA is connected to the VMB. The ARP entry may be used by the VMA to communicate with the VMB directly, and a packet for accessing the VMB by the VMA is not forwarded by the xTR1.

The ARP entry corresponding to the EID address of the VMA (i.e., 10.1.1.65) that has been learned by the VMB includes: 10.1.1.65, the MAC address of the VMA and an egress interface that is an interface through which the VMB is connected to the VMA. The ARP entry may be used by the VMB to communicate with the VMA directly, and a packet for accessing the VMA by the VMB is not forwarded by the xTR1.

When the VMB migrates from the xTRA to the xTRB, the EID address and MAC address of the VMB are unchanged.

When the VMB accesses another VM, if the VMB finds that the ARP entry corresponding to the EID address of the VM does not exist locally, the VMB sends an ARP packet. If the VMB finds that the ARP entry corresponding to the EID address of the VM exists locally, the VMB sends a data packet. Regardless of the ARP packet or the data packet, the source addresses of the packets sent by the VMB are both the EID address of the VMB.

When receiving the packet sent by the VMB, the xTRB queries the local interface-EID address record to determine whether the local interface-EID address record includes the source address of the received packet (i.e., the EID address of the VMB). If the local interface-EID address record does not contain the source address of the received packet (i.e., the EID address of the VMB), the xTRB sends a registration packet to the MS, and adds a new local interface-EID address record which contains the interface of the xTRB through which the VMB is connected and the EID address of the VMB. The EID address contained in the registration packet is the EID address of the VMB (i.e., 10.1.1.66), and the RLOC address contained in the registration packet is the RLOC address of the xTR2 (i.e., 2.2.2.2).

After receiving the registration packet sent by the xTRB, the MS finds that the RLOC address mapping to the EID address (i.e., 10.1.1.66) contained in the registration packet is 1.1.1.1, which is not identical to the RLOC address (i.e., 2.2.2.2) contained in the registration packet, and sends a map-notify packet to the RLOC address (i.e., 1.1.1.1). The map-notify packet contains a second flag bit recorded as S, and contains the EID address (i.e., 10.1.1.66) and the RLOC address (i.e., 2.2.2.2).

The xTRA corresponding to the RLOC address (i.e., 1.1.1.1) receives the map-notify packet, finds that the map-notify packet contains the second flag bit recorded as S, and determines that the map-notify packet is sent by the MS. The xTRA queries the local interface-EID address record to learn the EID address (i.e., 10.1.1.66) contained in the map-notify packet, and determines whether the RLOC address (i.e., 2.2.2.2) contained in the map-notify packet is identical to the RLOC address of the xTR1 (i.e., 1.1.1.1). If the RLOC address (i.e., 2.2.2.2) contained in the map-notify packet is not identical to the RLOC address of the xTR1 (i.e., 1.1.1.1), the xTRA determines that the VMB whose EID address is 10.1.1.66 migrates from the xTRA to the xTRB whose RLOC address is 2.2.2.2.

The xTRA queries the local interface-EID address record to learn that the interface corresponding to the EID address 10.1.1.66 is the interface A, determines that the interface A also corresponds to the EID address 10.1.1.65 except the EID address 10.1.1.66, and sends a free ARP packet through the interface A. The source address and destination address of the free ARP packet are the EID address 10.1.1.66 and the source MAC address of the free ARP packet is the MAC address of the xTR1. The xTRA encapsulates the EID address 10.1.1.65 and the RLOC address of the xTRA (i.e., 1.1.1.1) into a new map-notify packet containing a first flag bit, sends the new map-notify packet to the RLOC address 2.2.2.2, and deletes the local interface-EID address record including the interface A and the EID address of the VMB.

After receiving the free ARP packet sent by the xTRA, the VMA connected to the interface A updates a local ARP entry corresponding to the source address of the free ARP packet (i.e., the EID address 10.1.1.66). Subsequently, the VMA may access the EID address 10.1.1.66 according to the updated ARP entry. Since the egress interface in the updated ARP entry corresponding to the EID address 10.1.1.66 is the interface through which the VMA receives the free ARP packet, it can be ensured that a packet for accessing the EID address 10.1.1.66 by the VMA can be forwarded to the EID address 10.1.1.66 by the xTRA through the LISP network, rather than sent to the EID address 10.1.1.66 according to the original ARP entry corresponding to the EID address 10.1.1.66 before the VMB migrates. The original ARP entry may be used for accessing the EID address 10.1.1.66 directly by the VMA. Accordingly, flow interruption can be prevented when the VMA accesses the EID address 10.1.1.66.

After receiving the map-notify packet sent by the xTRA, the xTRB identifies the first flag bit contained in the map-notify packet, determines that the RLOC address (i.e., 1.1.1.1) contained in the map-notify packet is not identical to the RLOC address of the xTRB (i.e., 2.2.2.2), determines that the VMB migrates from the xTRA whose RLOC address is 1.1.1.1 to the xTRB, and sends a free ARP packet through the interface B through which the VMB is connected. The source address and destination address of the free ARP packet are the EID address (i.e., 10.1.1.1.65) contained in the map-notify packet, and the source MAC address of the free ARP packet is the MAC address of the xTRB. After receiving the free ARP packet sent by the xTRB, the VMB updates the local ARP entry corresponding to the source address of the free ARP packet (i.e., the EID address 10.1.1.65). Subsequently, the VMB may access the EID address 10.1.1.65 according to the updated ARP entry. Since the egress interface in the updated ARP entry corresponding to the EID address 10.1.1.65 is the interface through which the VMB receives the free ARP packet, it can be ensured that a packet for accessing the EID address 10.1.1.65 by the VMB can be forwarded to the EID address 10.1.1.65 by the xTRB through the LISP network, rather than sent to the EID address 10.1.1.65 according to the original ARP entry corresponding to the EID address 10.1.1.65 before the VMB migrates. The original ARP entry may be used for accessing the EID address 10.1.1.65 directly by the VMB. Accordingly, flow interruption can be prevented when the VMB accesses the EID address 10.1.1.65.

The foregoing is the description for the method provided by some examples of the present disclosure. Hereinafter, an apparatus will be described according to some examples of the present disclosure.

FIG. 5 is a diagram illustrating the structure of an apparatus for preventing flow interruption caused by the migration of a VM according to some examples of the present disclosure. The apparatus may be applied to a first xTR in a LISP network. As shown in FIG. 5, the apparatus includes an emigration processing unit 501 and an immigration processing unit 502.

When determining that a first VM migrates from the first xTR, the emigration processing unit 501 determines whether a second VM is connected to an interface of the first xTR to which the first VM is connected before the first VM migrates. When determining that the second VM is connected to the interface of the first xTR to which the first VM is connected before the first VM migrates, the emigration processing unit 501 sends a free ARP packet through the interface of the first xTR, and sends the EID address of the second VM and the RLOC address of the first xTR to a second xTR. The source address and destination address of the free ARP packet are the EID address of the first VM, and the second xTR is an xTR to which the first VM migrates from the first xTR.

When determining that a third VM migrates to the first xTR, the immigration processing unit 502 receives a second EID address and a second RLOC address sent by an xTR that connects the third VM before the third VM migrates to the first xTR, and determines whether the received second RLOC address is identical to the RLOC address of the first xTR. When determining that the received second RLOC address is not identical to the RLOC address of the first xTR, the immigration processing unit 502 sends a second free ARP packet whose source address and destination address are the received second EID address. In an example, it is possible that multiple VMs migrate to the first xTR. The immigration processing unit 502 receives an EID addresses and a RLOC addresses sent by an xTR that connects each of the multiple VMs before the VM migrates to the first xTR, and determines whether the received RLOC address is identical to the RLOC address of the first xTR. When determining that the received RLOC address is not identical to the RLOC address of the first xTR, the immigration processing unit 502 sends a free ARP packet whose source address and destination address are the received EID address.

The apparatus further includes a storing unit 503.

The storing unit 503 may store a record including the interface of the first xTR and the EID address of a VM connected to the interface of the first xTR.

The emigration processing unit 501 may query the storing unit 503 to determine an interface corresponding to the EID address of the first VM migrating from the first xTR.

The emigration processing unit 501 queries the storing unit 503 to determine whether the interface corresponding to the EID address of the first VM corresponds to the EID address of another VM.

When determining that the interface corresponding to the EID address of the first VM corresponds to the EID address of another VM, the emigration processing unit 501 determines that the second VM is connected to the interface corresponding to the EID address of the first VM. When determining that the interface corresponding to the EID address of the first VM does not correspond to the EID address of another VM, the emigration processing unit 501 determines that the second VM is not connected to the interface corresponding to the EID address of the first VM.

After sending the EID address of the second VM and the RLOC address of the first xTR to the second xTR or determining that another VM is not connected to the interface corresponding to the EID address of the first VM, the emigration processing unit 501 deletes the record including the interface corresponding to the EID address of the first VM and the EID address of the first VM from the storing unit 503.

In an example, a process of sending the EID address of the second VM and the RLOC address of the first xTR to the second xTR by the emigration processing unit 501 includes:
encapsulating the EID address of the second VM and the RLOC address of the first xTR into a map-notify packet and sending the map-notify packet to the second xTR. The map-notify packet contains a first flag bit for indicating that the map-notify packet is sent by an xTR.

In an example, a processing of receiving the EID address and the RLOC address sent by the xTR that connects the third VM before the third VM migrates to the first xTR, determining whether the received RLOC address is identical to the RLOC address of the first xTR, and when determining that the received RLOC address is not identical to the RLOC address of the first xTR, sending the free ARP packet whose source address and destination address are the received EID address by the immigration processing unit 502 includes:
receiving a second map-notify packet; and
identifying a first flag bit contained in the second map-notify packet, and determining whether a RLOC address contained in the second map-notify packet is identical to the RLOC address of the first xTR; when determining that the RLOC address contained in the second map-notify packet is not identical to the RLOC address of the first xTR, sending a free ARP packet through an interface to which the third VM migrating to the first xTR is connected. The source MAC address of the free ARP packet is the MAC address of the first xTR, and the source address and destination address of the free ARP packet are the EID address contained in the second map-notify packet.

When determining that the third VM migrates to the first xTR, the immigration processing unit 502 may further identify the interface to which the third VM migrating to the first xTR is connected, and make a record including the identified interface and the EID address of the third VM migrating to the first xTR.

And thus, the description for the apparatus provided by some examples of the present disclosure terminates.

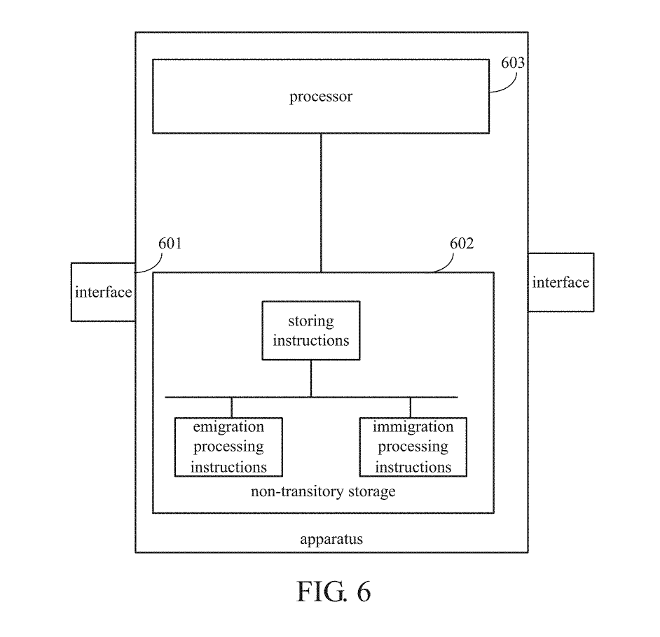

An example of the present disclosure also provides the hardware structure of the apparatus shown in FIG. 5, referring to FIG. 6. FIG. 6 is a diagram illustrating the hardware structure of an apparatus for preventing flow interruption caused by the migration of a VM according to some examples of the present disclosure. As shown in FIG. 6, the apparatus includes an interface 601, a non-transitory storage 602 and a processor 603.

The interface 601 may connect a VM.

The non-transitory storage 602 may store machine readable instructions, including emigration processing instructions and immigration processing instructions. When the machine readable instructions are executed by the processor 603, the functions of the apparatus shown in FIG. 5 can be implemented.

In an example, the non-transitory storage 602 may further storing instructions.

The processor 603 may communicate with the non-transitory storage 602, read and execute the machine readable instructions stored in the non-transitory storage 602 to implement the functions of the apparatus shown in FIG. 5.

And thus, the description for the hardware structure of the apparatus provided by some examples of the present disclosure terminates.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for preventing flow interruption caused by migration of a Virtual Machine (VM), applied to a first edge device (xTR) in a Locator/Identity Separation Protocol (LISP) network and comprising:
when determining that a first VM migrates from the first xTR, determining whether a second VM is connected to an interface of the first xTR to which the first VM is connected before the first VM migrates;
when determining that the second VM is connected to the interface of the first xTR to which the first VM is connected before the first VM migrates, sending a free Address Resolution Protocol (ARP) packet through the interface of the first xTR, and sending an Endpoint Identifier (EID) address of the second VM and a Routing Locator (RLOC) address of the first xTR to a second xTR,
wherein a source address and destination address of the free ARP packet are the EID address of the first VM, and the second xTR is an xTR to which the first VM migrates from the first xTR.

2. The method of claim 1, prior to determining that the first VM migrates from the first xTR, further comprising:
making a record including the interface of the first xTR and an EID address of a VM connected to the interface of the first xTR; wherein
determining whether the second VM is connected to the interface of the first xTR to which the first VM is connected before the first VM migrates comprises:
querying the record to determine an interface corresponding to the EID address of the first VM migrating from the first xTR;
querying the record to determine whether the interface corresponding to the EID address of the first VM corresponds to an EID address of another VM; and
when determining that the interface corresponding to the EID address of the first VM corresponds to the EID address of another VM, determining that the second VM is connected to the interface corresponding to the EID address of the first VM; when determining that the interface corresponding to the EID address of the first VM does not correspond to the EID address of another VM, determining that the second VM is not connected to the interface corresponding to the EID address of the first VM.

3. The method of claim 2, subsequent to sending the EID address of the second VM and the RLOC address of the first xTR to the second xTR or determining that another VM is not connected to the interface corresponding to the EID address of the first VM, further comprising:
deleting the record including the interface corresponding to the EID address of the first VM and the EID address of the first VM.

4. The method of claim 1, wherein sending the EID address of the second VM and the RLOC address of the first xTR to the second xTR comprises:
encapsulating the EID address of the second VM and the RLOC address of the first xTR into a map-notify packet and sending the map-notify packet to the second xTR, wherein the map-notify packet contains a first flag bit for indicating that the map-notify packet is sent by an xTR.

5. The method of claim 1, further comprising:
when determining that a third VM migrates to the first xTR, and receiving a second EID address and a second RLOC address sent by an xTR that connects the third VM before the third VM migrates to the first xTR, determining whether the received second RLOC address is identical to the RLOC address of the first xTR:
when determining that the received second RLOC address is not identical to the RLOC address of the first xTR, sending a second free ARP packet whose source address and destination address are the received second EID address.

6. The method of claim 5, wherein receiving the second EID address and the second RLOC address sent by the xTR that connects the third VM before the third VM migrates to the first xTR, determining whether the received second RLOC address is identical to the RLOC address of the first xTR, and when determining that the received second RLOC address is not identical to the RLOC address of the first xTR sending the second free ARP packet whose source address and destination address are the received second EID address comprises:
receiving a second map-notify packet; and
identifying a first flag bit contained in the second map-notify packet, determining whether a RLOC address contained in the second map-notify packet is identical to the RLOC address of the first xTR; when determining that the RLOC address contained in the second map-notify packet is not identical to the RLOC address of the first xTR, sending a free ARP packet through an interface to which the third VM migrating to the first xTR is connected, wherein a source Media Access Control (MAC) address of the free ARP packet is a MAC address of the first xTR, and a source address and destination address of the free ARP packet are an EID address contained in the second map-notify packet.

7. The method of claim 5, when determining that the third VM migrates to the first xTR, further comprising:
identifying an interface through which the third VM migrating to the first xTR is connected, and making a record including the identified interface and an EID address of the third VM migrating to the first xTR.

8. An apparatus for preventing flow interruption caused by migration of a Virtual Machine (VM), applied to a first edge device (xTR) in a Locator/Identity Separation Protocol (LISP) network, comprising an emigration processing unit:
when determining that a first VM migrates from the first xTR, the emigration processing unit is to determine whether a second VM is connected to an interface of the first xTR to which the first VM is connected before the first VM migrates; when determining that the second VM is connected to the interface of the first xTR to which the first VM is connected before the first VM migrates, to send a free Address Resolution Protocol (ARP) packet through the interface of the first xTR, and send an Endpoint Identifier (EID) address of the second VM and a Routing Locator (RLOC) address of the first xTR to a second xTR, wherein a source address and destination address of the free ARP packet are an EID address of the first VM, and the second xTR is an xTR to which the first VM migrates from the first xTR.

9. The apparatus of claim 8, further comprising:
a storing unit, to store a record including the interface of the first xTR and an EID address of a VM connected to the interface of the first xTR wherein
the emigration processing unit is to query the storing unit to determine an interface corresponding to the EID address of the first VM migrating from the first xTR; to query the storing unit to determine whether the interface corresponding to the EID address of the first VM corresponds to an EID address of another VM; when determining that the interface corresponding to the EID address of the first VM corresponds to the EID address of another VM, to determine that the second VM is connected to the interface corresponding to the EID address of the first VM; when determining that the interface corresponding to the EID address of the first VM does not correspond to the EID address of another VM, to determine that the second VM is not connected to the interface corresponding to the EID address of the first VM.

10. The apparatus of claim 9, wherein, subsequent to sending the EID address of the second VM and the RLOC address of the first xTR to the second xTR or determining that another VM is not connected to the interface corresponding to the EID address of the first VM, the emigration processing unit is to delete the record including the interface corresponding to the EID address of the first VM and the EID address of the first VM from the storing unit.

11. The apparatus of claim 8, wherein the emigration processing unit is to encapsulate the EID address of the second VM and the RLOC address of the first xTR into a map-notify packet and send the map-notify packet to the second xTR, wherein the map-notify packet contains a first flag bit for indicating that the map-notify packet is sent by an xTR.

12. The apparatus of claim 8, further comprising an immigration processing unit, wherein
when determining that a third VM migrates to the first xTR, the immigration processing unit is to receive a second EID address and a second RLOC address sent by an xTR that connects the third VM before the third VM migrates to the first xTR, and determine whether the received second RLOC address is identical to the RLOC address of the first xTR; when determining that the received second RLOC address is not identical to the RLOC address of the first xTR, to send a second free ARP packet whose source address and destination address are the received second EID address

13. The apparatus of claim 12, wherein the immigration processing unit is to receive a second map-notify packet; identify a first flag bit contained in the second map-notify packet, and determine whether a RLOC address contained in the second map-notify packet is identical to the RLOC address of the first xTR; when determining that the RLOC address contained in the second map-notify packet is not identical to the RLOC address of the first xTR, send a free ARP packet through an interface to which the third VM migrating to the first xTR is connected; wherein a source Media Access Control (MAC) address of the free ARP packet is a MAC address of the first xTR, and a source address and destination address of the free ARP packet are an EID address contained in the second map-notify packet.

14. The apparatus of claim 12, wherein, when determining that the third VM migrates to the first xTR, the immigration processing unit is to identify the interface to which the third VM migrating to the first xTR is connected, and make a record including the identified interface and the EID address of the third VM migrating to the first xTR.
